(19) United States
(12) Patent Application Publication
(10) Pub. No.: US 2023/0315979 A1
(43) Pub. Date: Oct. 5, 2023

(54) SYSTEM AND METHOD FOR DIGITAL ASSET MANAGEMENT

(71) Applicant: Desygner Pte. Ltd., Singapore (SG)

(72) Inventor: Alexander David William Rich, Surfers Paradise (AU)

(73) Assignee: Desygner Pte. Ltd., Singapore (SG)

(21) Appl. No.: 18/182,374

(22) Filed: Mar. 13, 2023

Related U.S. Application Data
(60) Provisional application No. 63/362,047, filed on Mar. 29, 2022.

(51) Int. Cl. G06F 40/186; G06F 40/42

(52) U.S. Cl. CPC G06F 40/186; G06F 40/42

(57) ABSTRACT

A system and method for digital asset management. The system comprises a processor configured with a memory, and the processor is capable of executing a plurality of modules stored in the memory. The processor is configured to input a request from a user device and retrieve an asset identifier and a filed identifier of the digital asset. Further, the processor searches other digital assets linked with the digital assets based on the asset identifier and compares the retrieved field identifier of the digital asset within the other digital assets. The plurality of digital assets are accessible by the processor. Furthermore, the processor performs the request upon detecting a match of the field identifier of the digital asset.

### TECHNICAL FIELD

The present invention generally relates to digital asset management. More specifically, the present invention relates to a system and method for digital asset management.

### BACKGROUND ART

In the digital era, organisations have digital assets. The digital assets include brand, non-brand templates and digital files. While using such assets for marketing, corporate promotion, or any other purpose, changes or alterations in a part or section of the digital assets may require from time to time, as such digital assets are enormous in size, the existing methods and systems based on the manual intervention may lead to incorrect outcomes.

Further, in case the required changes or alterations are related to the digital asset's properties, content information, content language, formats, objects etc. then for making such changes or alterations with manual interventions, the process becomes tedious, error prone, time consuming and may not adhere with legal compliance, e.g. missing a whole document, missing to replace the information in the document or updating a document with the wrong information.

Therefore, there is a need in the art of digital asset management to overcome the aforementioned deficiencies.

### OBJECTS OF THE INVENTION

Some of the objects of the present invention are listed below:

It is an object of the present invention to provide a system and method for digital asset management;

It is an additional object of the present invention to provide system and method for digital asset management, which enables fast, efficient and error-free updates, changes or alterations in the digital assets;

It is an additional object of the present invention to provide digital asset management in which the processing time is reduced by optimizing iterations or alterations;

It is an additional object of the present invention to provide reliable translations of textual content in the digital assets, by means of generating requests for translation and audit trails;

It is an additional object of the present invention to provide digital asset management having optimized workflow; and

It is an additional object of the present invention to provide ease of management and alteration of relevant corporate brand information across a large number of documents and to provide ease of management of translations of textual brand information across multiple language versions of various corporate documents.

Other objects, features, advantages, and goals of the present invention will be better understood from the following detailed description taken in conjunction with the accompanying drawings.

### SUMMARY

According to the first aspect of the present invention, the system comprises a processor configured with a memory, and the processor is capable of executing a plurality of modules stored in the memory. The processor is configured for inputting a request from a user device and retrieving an asset identifier of the digital asset and a field identifier of the digital asset. Further, the processor performs searching other digital assets linked with the digital asset based on the asset identifier and compares the retrieved the field identifier of the digital asset within the other digital assets. The plurality of digital assets are accessible by the processor. Furthermore, the processor performs the request upon detection of a match of the field identifier of the digital asset.

In one embodiment of the invention, the asset identifier and the field identifier of the digital asset are stored into distributed ledgers or centralized ledgers.

In one embodiment of the invention, the system comprises a workflow sub-system and translation management sub-system.

In one embodiment of the invention, the digital asset includes document, audio, video, logo, slide presentation, spreadsheet, website, digital files etc.

A SaaS (Software as a Service) platform is used to deploy an API (Application Program Interface) on the web, iOS, Android, or other operating systems in one embodiment of the invention. Thus, it enables individuals and organizations to organize events marketing campaigns collaboratively while maintaining the consistency of a brand or intellectual properties.

According to a second aspect of the present invention, a method for digital asset management is provided. The method uses a plurality of algorithms and program codes for managing the digital assets, and the algorithms are based on Artificial Intelligence (AI) and Machine Learning (ML) techniques.

The following detailed description is illustrative and is not intended to be in any way limiting. In addition to the illustrative aspects, embodiments, and features described above, further aspects, embodiments, and features will be apparent by reference to the following detailed description in conjunction with the accompanying drawings.

### BRIEF DESCRIPTION OF THE ACCOMPANYING DRAWINGS

The accompanying drawings illustrate the best mode for carrying out the invention as presently contemplated and set forth hereinafter. The present invention may be more clearly understood from a consideration of the following detailed description of the preferred embodiments taken in conjunction with the accompanying drawings wherein like reference letters, and numerals indicate the corresponding parts in various figures in the accompanying drawings, and in which:

FIG. 1 illustrates a network implementation of a system for digital asset management, in accordance with an embodiment of the present invention;

FIG. 2 illustrates a method for digital asset management, in accordance with an embodiment of the present invention; and

FIG. 3 illustrates the details of digital assets and the linkage with other digital assets.

While the present invention is susceptible to various modifications and alternative forms, specific embodiments are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims and equivalents thereof.

### DETAILED DESCRIPTION

Embodiments of the present invention disclosure will be described more fully hereinafter with reference to the accompanying drawings in which like numerals represent like elements throughout the figures, and in which example embodiments are shown.

The detailed description and the accompanying drawings illustrate the specific exemplary embodiments by which the disclosure may be practiced. These embodiments are described in detail to enable those skilled in the art to practice the invention illustrated in the disclosure. It is to be understood that other embodiments may be utilized, and other changes may be made, without departing from the spirit or scope of the present disclosure. Therefore, the following detailed description is not to be taken in a limiting sense, and the appended claims define the scope of the present invention disclosure. Embodiments of the claims may, however, be embodied in many different forms and should not be construed as limited to the embodiments set forth herein.

The present invention provides a system and method of digital asset management, enabling fast, efficient and error-free updates, changes, or alterations in the digital assets. The digital assets may include but are not limited to documents, audio, videos, logos, slide presentations, spreadsheets, websites, etc.

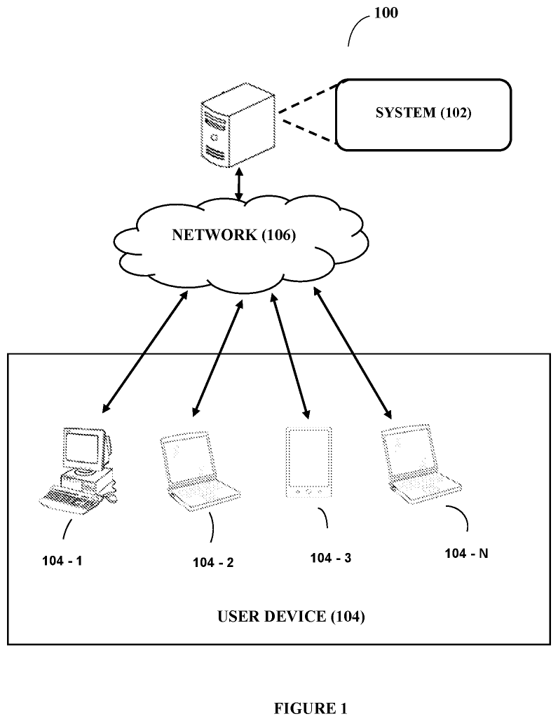

FIG. 1 illustrates a digital asset management system 100 includes a system 102. Although the present disclosure is explained considering that the system 102 is implemented on a server, however, the system 102 may be implemented in a variety of computing systems such as a laptop, a desktop, a notebook, a workstation, a mainframe computer, a server, a network server, a cloud-based computing environment. In addition, it will be understood that the system 102 may be accessed by multiple users through one or more user devices 104-1, 104-2 . . . 104-N, collectively referred to as user or stakeholders, or applications residing on the user devices 104.

In one implementation, the system 102 may comprise the cloud-based computing environment in which a user may operate individual computing systems configured to execute remotely located applications. Examples of the user devices 104 may include but are not limited to a portable computer, a personal digital assistant, a handheld device, and a workstation. The user devices 104 are communicatively coupled to the system 102 through a network 106.

The system 102 comprises a processor configured with a memory, and the processor is capable of executing a plurality of modules stored in the memory. The processor is configured for inputting a request from a user device and retrieving an asset identifier and a field identifier of the digital asset. The request may be related to updating, replacing, adjusting, altering, adding and deleting a property, an object and an element of the digital asset and translating the content or information of the digital assets. The asset identifiers link the plurality of digital assets, and the field identifier of the digital asset is defined as unique.

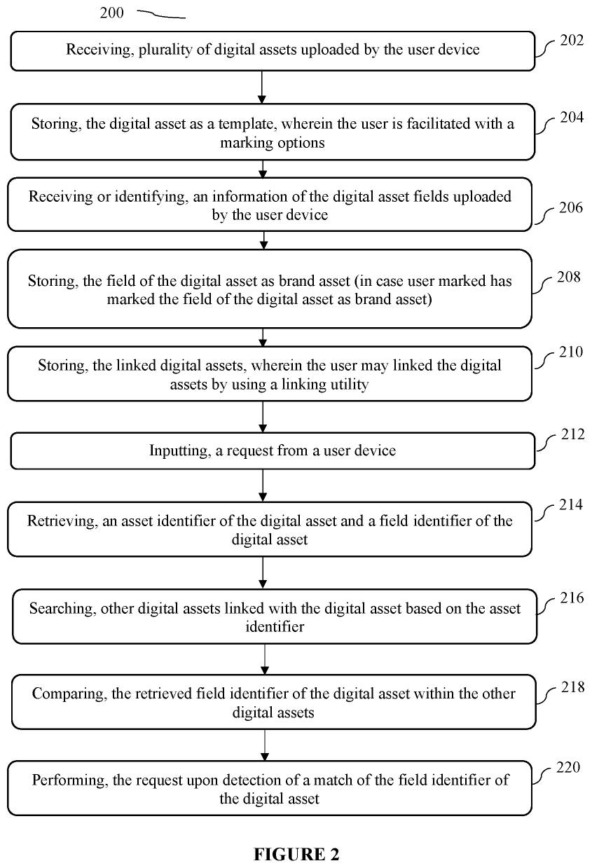

FIG. 2 illustrates a method 200 for digital asset management. Method 200 comprising the below steps:

At step 202, the processor receives a plurality of digital assets, wherein the digital assets are uploaded by the user device 104. For example, the digital assets are documents, audios, videos, logos, slide presentations, spreadsheets, websites and digital files.

At step 204, the digital assets are stored as a template by the processor in a database. The user may mark the digital asset as the template, as the user is facilitated with a plurality of marking options.

At step 206, information of the digital asset fields is received by or identified by the processor. The user device may upload the information of the digital asset fields, or the system 102 may identify the relevant information of the digital asset fields by using Artificial Intelligence or Machine Learning algorithm. The information of the field of the digital asset may be related to the positioning of the logos, fonts, colours, corporate slogans, phone numbers, e-mail IDs etc.

At step 208, the field of the digital asset stored as a brand asset/smart asset by the processor in the database, in case the user has marked the field as the brand asset, so the data belongs to the field like logo, images, email IDs etc. stored as the brand/smart asset. i.e., the brand asset gets defined as actual logo design, email IDs etc. The user is facilitated with the plurality of marking options to mark the information of the digital asset fields as the brand/smart asset. The marking option is based on a visual editor.

At step 210, the linked digital assets are stored by the processor in the database, wherein the user may link the digital assets using a linking utility. Due to the linking utility, the system auto-propagates alterations in all the linked digital assets.

At step 212, a user device request is received by the processor. For example, a customer wants to alter the brand asset, such as the corporate logo.

At step 214, an asset identifier of the digital asset and a field identifier of the digital asset are received or identified by the processor. The field identifier may be related to the field's positioning or location in the digital asset.

At step 216, other digital assets linked with the digital assets are searched based on the asset identifier;

At step 218, the retrieved field identifier of the digital asset gets compared within the other digital assets, wherein the plurality of the digital assets are accessible by the processor;

At step 220, the request is performed upon detecting a match of the field identifier of the digital asset.

For example, if the user wants to alter the brand/smart asset (here refer as logo) of the digital asset, the user request is generated by the user device. Then system 102 identifies the digital asset identifier and the field identifier related to the brand asset. After that, the system 102 searches for the other digital assets linked with the digital assets (herein referred to a template). Then, the identified field identifier of the digital asset gets compared with the other digital assets. If the match of field identifier is found, then the brand/smart asset is altered in all the linked digital assets.

For another example, the customer alters a textual brand asset in multiple versions (based on language) of several documents. In addition to the approval and auto-propagation steps described above, the system 102 also transmits the alteration information to a translation manager, a registered member of the company's account. The translation manager performs the translation, after which the translated content is auto-propagated to all linked documents.

In an exemplary embodiment, if the customer has configured the asset, as the alteration in the asset requires approval from authorities, a job request is generated by the processor and the job request is transmitted to a relevant administrator. Upon approval, the altered content gets auto-propagates and the processor replaces the original content across all the digital assets or documents that contain such content. This replacement process maintains the document's visual aesthetics and consistency.

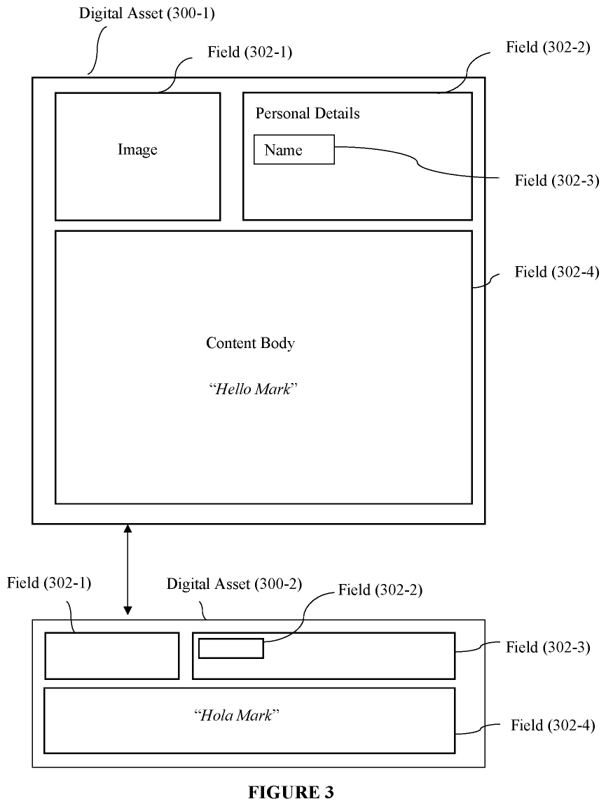

The digital assets are documents, audios, videos, logos, slide presentations, spreadsheets, websites, and digital files in an exemplary embodiment. The asset identifiers and the field identifier of the digital asset may be stored in the form of a linked list or any other suitable form of data structure. Information of the digital asset field may be related to logos, colours, fonts, stock imagery, and textual information such as names, phone numbers, e-mail addresses, job titles, etc. FIG. 3 illustrates the details of the digital asset and the linkage with the other digital asset. For example, the digital asset 300-1 is a presentation slide having the plurality of field as an image 302-1, a personal detail 302-2, a name 302-3 and a content body field 302-4. The content body field 302-4 has data, i.e., “Hello Mark”. The other digital asset 300-2 is a world document having similar field identifiers.

In case the user wants to change the data of the brand asset, i.e., the content body field 302-4. The user is only required to change the data into the single digital asset 300-1. The system 102 inputs the request from the user. After that, the system 102 retrieves the digital asset 300-1 and the field identifier of the digital asset 300-1. The system 102 searches other digital assets (herein referred to other digital assets) 300-2 linked with the digital asset 300-1 based on the asset identifier. After that, the system 102 compares the retrieved field identifier of the digital asset (herein referred to a template) 300-1 with the field identifier of the other digital asset (herein referred to other digital assets) 300-2. If the field identifier of the other digital asset 300-2 gets matched with the digital asset 300-2, the system auto-propagates similar changes to the other digital asset 300-2.

Again referring to FIG. 3, the field identifier of the content body field 302-4 is the same for both digital assets 300-1 and 300-2. Thus, when the user changes the brand asset (content body) into the digital asset 300-1 (also referred to as a template). The similar changes are auto-propagated into the digital asset 300-2.

Further, in case the digital asset 300-2 is in a different language (language other than the digital asset 300-1). The system 102 generates the request for a translation expert (a member of a service provider) to translate the changed content to any other language like French, Spanish, Portuguese, etc. and thus, the translation auto-propagated or auto reflected into the content body field 302-4 of the digital asset 300-2. For example, “Hello Mark” is translated and auto changes to “Hola Mark,” which is Spanish.

Further in another exemplary embodiment, when any customers require changing the information of the digital asset fields, like logos, job roles and titles, legal disclaimers, etc., the system 102 enables to change the required information of the field centrally (i.e., the digital asset stored at a central location) in only one location. After that, the system 102 automatically propagate the centralised alteration to all other digital assets containing the said field with automatic visual adjustments as necessary. For example, the digital asset 300-1 is stored at a central location, marked and stored as a template.

Additionally, alterations requiring authorized approval uses a workflow management sub-system. The auto-propagation of the alteration across the digital assets gets triggered or initiated only after receiving approval from authorities.

Further, the processor searches other digital assets linked with the digital asset based on the asset identifier by using various searching and sorting algorithms and compares the retrieved field identifier of the digital asset within the other digital assets. The plurality of digital assets are accessible by the processor. The digital assets may be stored in distributed ledgers or centralized ledgers.

Furthermore, the processor performs the request of the user upon detection of a match of the field identifier of the digital asset. For example, if the user wants to change the personal details, the user must change the personal details fields in a document stored centrally and system 102 updates the changed fields within the linked documents.

As another example, in case the request is for translation of the field information, the processor generates a request to a translator for translation of the field information of the digital asset, wherein the translator is a translation sub-system configured within the system 102 or an active operator at a backend of the system 102.

A translation module or sub-system is used in an exemplary embodiment for translation management. The digital assets may be linked to each other. For example, a document in English and corresponding documents in French, Spanish, Portuguese, etc., are linked on the system 102. When a textual asset is altered or translated in the English language document, the system 102 generates the request for a translation expert (a member of a service provider) to translate the altered content to French, Spanish, Portuguese, etc. Thus, the translation is auto-propagated or reflected in all the linked documents.

### Example 1

As an example of the digital asset management system 100, an organization is relocating the main office to another address. Thus, the organization requires updating address information on business cards, contracts, brochures, documents, etc. The user needs to update the information only once in the template stored centrally, by using the system 102 and the system 102 updates the address into the same fields of all the linked documents. Thus, instead of updating the address manually in all the documents, by using the system 102 the organization requires only to update the information at once.

### Example 2

As another example of the digital asset management system 100, a company has a new Chief Executive Officer (CEO). Thus, a name, contact details and a picture of the CEO are required to update in all the official documents and the company's internal communications systems. By using the system 102, the user requires to update the information (here refer as CEO details: Name, Email Address, Phone Number and Profile picture) only one time in the template by using the system 102 and the system 102 updates the address into the same fields of all the linked documents.

Thus, the user requires to replace the content of the fields only once and the system 102 automatically replaces the content of the fields in all the linked documents.

### Example 3

As another example of the digital asset management system 100, a company is updating a disclaimer used in contracts in multiple languages. The main disclaimer is drafted in English language. Using the system 102, the user requires to update a single document. Afterwards, the translated content is transmitted in all the linked documents it is used (in reference to Example 2). Further, the company establishes contracts in other languages, French or Spanish. The French and Spanish contracts are using 2 (two) textual content fields for the disclaimer in Spanish and French. Because of the system 102 an update made in English disclaimer fields, automatically updates in French and Spanish disclaimer fields. Because the French and Spanish disclaimer field has been updated, all the contract/documents using the French and Spanish fields are automatically updated with the updated textual content.

In another embodiment, the method 200 for the digital asset management is disclosed. The method uses a plurality of algorithms and program codes for managing the digital assets and the algorithms are based on Artificial Intelligence (AI) and Machine Learning (ML) techniques.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A system for digital asset management, comprising:
a processor configured with a memory, wherein the processor is capable of executing a plurality of modules stored in the memory and the processor is configured for:
inputting, a request from a user device;
retrieving, an asset identifier of the digital asset and a field identifier of a field of the digital asset;
searching, other digital assets linked with the digital asset based on the asset identifier;
comparing, the retrieved field identifier of the digital asset within the other digital assets, wherein the plurality of the digital assets are accessible by the processor;
performing, the request upon detection of a match of the field identifier of the digital asset.

2. The system as claimed in claim 1, wherein the request is to update, replace, adjust, alter, add and delete a property, an object and an element of the digital asset and translate a content or an information of the digital assets.

3. The system as claimed in claim 1, wherein the plurality of digital assets are linked by the asset identifiers and the field identifier of the digital asset is defined as unique.

4. The system as claimed in claim 1, wherein the digital assets are documents, audios, videos, logos, slide presentations, spreadsheets, websites and digital files.

5. The system as claimed in claim 1, wherein the processor generates a request to a translator for translation of the content of the digital asset, wherein the translator is a translation sub-system configured within the system or an active operator at a backend of the system.
